(19) United States
(12) Patent Application Publication
(10) Pub. No.: US 2024/0110002 A1
(43) Pub. Date: Apr. 4, 2024

(54) NOVEL POLYURETHANE OR POLYURETHANE-UREA COMPOSITION WITH ENHANCED LOW TEMPERATURE PERFORMANCE

(71) Applicant: INGEVITY UK LTD, Cheshire (GB)

(72) Inventors: Joel Neale, Cheshire (GB); Scott D. Phillips, Cheshire (GB)

(21) Appl. No.: 18/451,344

(22) Filed: Aug. 17, 2023

Related U.S. Application Data
(60) Provisional application No. 63/378,055, filed on Oct. 1, 2022.

(51) Int. Cl. C08G 18/48; C08G 18/32; C08G 18/66; C08G 18/76

(52) U.S. Cl. CPC C08G 18/4887; C08G 18/3206; C08G 18/6674; C08G 18/7671

(57) ABSTRACT

The present application discloses polyurethane or polyurethane-urea compositions with enhanced low temperature performance that includes a reaction product of: at least one diisocyanate and at least one block copolymer of A-B-A type that has an average number molecular weight of 2500-5000 g/mol, wherein the reaction product is formed in the absence of a plasticizer by reacting the reactants in an NCO:OH molar ratio of 0.9:1-2:1. The block copolymer being the reaction product of (i) a poly(tetrahydrofuran) diol in an amount of 40-70 wt % of the total molecular weight of the block copolymer, wherein the tetrahydrofuran is optionally substituted and (ii) a cyclic lactone and/or cyclic ether in an amount of 30-60 wt % of the total molecular weight of the block copolymer. The present disclosure further discloses the reaction further comprising a diol or a diamine chain extender, and compositions comprising the polyurethane or polyurethane-urea composition of the present disclosure.

### CROSS-REFERENCE TO RELATED APPLICATIONS

The present application claims priority to, and the benefit of, U.S. Provisional Patent Application No. 63/378,055, filed 1 Oct. 2022, which is incorporated by reference herein in its entirety for all purposes.

### FIELD OF THE INVENTION

The present disclosure describes novel polyurethane or polyurethane-urea compositions with enhanced performance at low temperature and methods of making the same, as well as compositions comprising the same and methods of using the same.

### BACKGROUND

Polyurethane (PU) elastomers are versatile materials that allow access to a range of mechanical and physical properties. Polyurethane elastomers are known for viscoelasticity, toughness, and durability in a wide variety of environmental conditions. The boundaries of what can be achieved with such materials is continually being pushed and its modular nature allows manipulation of the chemical structure to give the desired performance. Maintaining performance at low temperature extremes is one such target that can be addressed using this technology, affording materials that are often viewed as mechanically superior, easily processable alternatives to silicone elastomers and ethylene propylene diene monomer (EPDM). Boosting the low temperature limit of performance of PU materials whilst maintaining high temperature performance—in effect increasing the operating window of articles—has a wide variety of commercial opportunities in, for example, transportation, aerospace, footwear, manufacturing, construction, and medical markets. The ability to operate at both low and high temperatures has value in a host of end uses from industrial wheels and rollers, automotive bushings, mechanical seals, snow sports, and other outdoor footwear.

The low temperature performance of polyurethane materials is typically assessed using thermal analysis techniques, such as Differential Scanning calorimetry (DSC) and thermomechanical techniques or Dynamic Mechanical Analysis (DMA). A material's glass transition temperature (Tg) is often used as a key indicator—but not the only indicator—of low temperature performance. A useful definition of the glass transition temperature for a polymer is the temperature at, or above which, the molecular structure exhibits macromolecular mobility. For a segmented polymer, such as polyurethane, this is the point at which a material transitions from a glassy thermoplastic material into the flexible, rubbery state that one would anticipate from an elastomer. The glass transition can be determined experimentally using either the DSC technique or the DMA techniques. When employing DSC, the glass transition is observed as a step in the baseline of the measurement curve when a material is heated at a constant rate, corresponding to a change in the heat capacity of a material when it makes the transition from a glassy material to one with molecular motion. In DMA, the glass transition is often defined as the maximum in tan δ.

Above the glass transition temperature, due to their unique segmented semi-crystalline structure, polyurethane materials can exhibit viscoelastic behavior. This means that they are capable of storing energy to be returned as an elastic response, or of the loss of energy as heat, when a load is applied then removed. Tan δ is the ratio of loss modulus to storage modulus in a DMA experiment and provides an indication of how easily elastic energy is stored or lost during a deformation—relaxation cycle—that is, it represents the damping capability of a material. This is why tan δ is also referred to as the damping factor. A high performing elastomer should possess a tan δ well below 0.1 above the materials glass transition temperature. To ensure consistent performance at low temperatures, it is desirable for tan δ to be below 0.1 and stable to as low a temperature as possible. The minimum use temperature is considered the temperature at which tan δ exceeds 0.1.

Polycaprolactones are a unique class of polyester polyol that are used in the production of polyurethane elastomers. Polyurethanes based on polycaprolactones are characterized by best-in-class mechanical properties, outstanding durability in harsh environmental conditions, and processing ease compared to many competitive materials. For this reason, polycaprolactones find use in very demanding applications where articles are exposed to high temperatures, humid environments, UV light, and repeated mechanicals deformations, such as in industrial seals, gaskets, wheels and rollers, paint protection films, and in automotive suspension systems. However, like most technologies based on polyester polyols, a limitation of the technology is performance at low temperature extremes. This severely limits its use in industrial applications that need to exhibit constant performance at low and high temperature extremes.

Other chemical technologies can be employed to give low temperature performance benefits. Poly(tetramethylene ether) glycols (PTMEG) are a common alternative to polyester polyols, such as polycaprolactones, when low temperature performance is critical. The glass transition temperature of polyurethane articles produced using PTMEG can be lowered by up to 25° C. compared to those based on polyester polyols. However, such polyurethanes are known to be less mechanically robust, have poor high temperature performance, and be prone to degradation by ultraviolet (UV) light. The PTMEG market has also been volatile in recent years with polyurethane producers experiencing poor product availability and erratic pricing.

Polycaprolactone copolymers, such as Capa® 7201A, marketed by Ingevity Corporation, are also known to have improved low temperature performance compared to polyester polyols. Capa® 7201A is a 2000 g/mol triblock copolymer of PTMEG and caprolactone where PTMEG is 50% of the polyol by weight. Polyurethane articles made with Capa® 7201A typically have a glass transition temperature intermediate to that of a polycaprolactone copolymer and PTMEG. Whilst the copolymer uses PTMEG as a raw material, the dependence on this technology is reduced by 50% when substituting PTMEG homopolymer in a polyurethane composition. Whilst offering a compromise between PTMEG and polycaprolactone technologies, the low temperature performance of Capa® 7201A, as indicated by the glass transition temperature, is still somewhat inferior to PTMEG.

As well as modifying the chemical technology, one can increase the molecular weight of the polyol chain in the polyurethane to lower the glass transition temperature. For example, replacing a 1000 g/mol PTMEG with a 2000 g/mol PTMEG in a polyurethane formulation leads to the glass transition temperature being lowered. This results from the greater polyol chain mobility, which means less energy is required for molecular motion. U.S. Patent Application Publication No. 2002/0077444 describes the use of polycaprolactone copolymers based on methyl-PTMEG (MePTMEG) and polycaprolactone of 2294 g/mol in a patent claiming a method for production of liquid polyurethane prepolymers.

However, beyond a certain molecular weight, crystallization of the polyol chains means that despite a low glass transition, viscoelastic behavior is not exhibited until a much higher temperature—that is, the minimum use temperature is higher. This molecular weight limit on low temperature performance is observed in both polyurethanes made with PTMEG and polycaprolactone technology. When employing polyols above 2500 g/mol, a broad glass transition is observed (a consequence of polyol crystallinity) and despite the peak Tg being low, the minimum use temperature is considerably higher.

Thus, there is a need for a polyurethane with improved low temperature performance. The present disclosure addressed this need with novel polyurethane compositions based on higher molecular weight polycaprolactone copolymers that exhibit very low glass transition and very low minimum use temperatures, overcoming the challenges with polyol crystallinity in conventional polyurethane systems.

### SUMMARY

Surprisingly and unexpectedly, it was discovered that when copolymers of poly(tetrahydrofuran) or poly(substituted tetrahydrofuran) and a cyclic lactone/ether (e.g., caprolactone), wherein (i) the copolymer having molecular weight above 2500 g/mol, (ii) the poly(tetrahydrofuran)/poly(substituted tetrahydrofuran) content is at least 40% by weight of the copolymer, are used as the soft segment in polyurethane articles, the low temperature performance is dramatically improved. The glass transition temperature, which can be measured by Differential Scanning calorimetry (DSC) and/or Dynamic Mechanical Analysis (DMA), is on par with poly(tetramethylene ether) glycols (PTMEG) but more importantly the minimum use temperature (defined as the lowest temperature where tan delta is below 0.1) is extended by up to 25° C. This was surprising and unexpected because polyol crystallization generally increases as the molecular weight increases, raising the minimum use temperature. Polyurethanes based on the copolymers of the present disclosure have hitherto not been reported, likely due to the belief by those skilled in the that polyol crystallinity would prevent useful materials being produced.

An aspect of the present disclosure relates to a polyurethane or polyurethane-urea composition with enhanced low temperature performance. In any aspect or embodiment described herein, the polyurethane or polyurethane-urea composition comprises a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer; and
(b) at least one diisocyanate,
wherein the polyurethane or polyurethane-urea composition reaction product is formed by reacting (e.g., in the absence of a plasticizer) (a) and (b) in an NCO:OH molar ratio of from about 0.9:1 to about 2:1.

In any aspect or embodiment described herein, the reaction further comprises (c) a diol chain extender, diamine chain extender, or mixture thereof, each having a molecular weight from about 60 to about 600, wherein the polyurethane or polyurethane-urea composition reaction product is formed by reacting (e.g., in the absence of a plasticizer) (a), (b), and (c) in an NCO:OH molar ratio of from about 0.9:1 to about 2:1.

In any aspect or embodiment described herein, the polyurethane or polyurethane-urea composition comprises a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer;
(b) at least one diisocyanate; and
(c) a diol chain extender, diamine chain extender, or mixture thereof, each having a molecular weight from about 60 to about 600, wherein the polyurethane or polyurethane-urea composition reaction product is formed by reacting, in the absence of a plasticizer, (a), (b), and (c) in an NCO:OH molar ratio of from about 0.9:1 to about 2:1.

In any aspect or embodiment described herein, reactant (b) is present in an amount of about 50 to about 70 wt % of the total molecular weight of the block copolymer.

In any aspect or embodiment described herein, the composition has a hardness of about 30 Shore A to about 60 Shore D.

In any aspect or embodiment described herein, the NCO:OH molar ratio is about 0.9:1 to about 1.7:1.

In any aspect or embodiment described herein, the NCO:OH molar ratio is about 0.95:1 to about 1.5:1.

In any aspect or embodiment described herein, the NCO:OH molar ratio is about 1:1 to about 1.2:1.

In any aspect or embodiment described herein, the polyurethane or polyurethane-urea composition has a glass transition temperature, as measured by Differential Scanning calorimetry, that is below −60° C.

In any aspect or embodiment described herein, the polyurethane or polyurethane-urea composition has a glass transition temperature, as measured by Dynamic Mechanical Analysis, that is below −40° C.

In any aspect or embodiment described herein, reactant (i) includes or is a poly(substituted tetrahydrofuran) diol. For example, in any aspect or embodiment described herein, reactant (i) includes or is a poly(substituted tetrahydrofuran) diol, wherein substituted includes or is one or more (e.g., 1, 2, 3, 4, 5, 6, or more) substitutions independently selected from a C₁₋₄ alkyl (for example, a methyl, ethyl, or propyl), C₁₋₆ alkoxy (for example, methoxy or ethoxy), C₂₋₆ alkenyl, aromatic (e.g. phenyl, aryl, or heteroaryl), ester, halogen, halide, amide, or ketone.

In any aspect or embodiment described herein, the poly(tetrahydrofuran) diol or reactant (i) includes or is poly(tetramethylene ether) glycol (PTMEG).

In any aspect or embodiment described herein, the poly(substituted tetrahydrofuran) diol or reactant (i) includes or is Me-PTMEG.

In any aspect or embodiment described herein, the cyclic lactone includes or is ε-caprolactone.

In any aspect or embodiment described herein, the cyclic ether includes or is ethylene oxide, propylene oxide, 1,2-butylene oxide, 2,3-butylene oxide, or a mixture thereof.

In any aspect or embodiment described herein, the diisocyanate includes or is an aliphatic diisocyanate, aromatic diisocyanate, or a combination thereof. For example, in any aspect or embodiment described herein, the diisocyanate includes or is 4,4′-diphenylmethane diisocyanate, isophorone diisocyanate, bimethylene diisocyanate, trimethylene diisocyanate (e.g., 1,3-trimethylene diisocyanate, 2,3-trimethylene diisocyanate, 1,2-trimethylene diisocyanate, 2,2-trimethylene diisocyanate, or a mixture thereof), tetramethylene diisocyanate (e.g., 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, or a mixture thereof), pentamethylene diisocyanate (e.g., 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, or a mixture thereof), hexamethylene diisocyanate (e.g., 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, or a mixture thereof), heptamethylene diisocyanate (e.g., 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, or a mixture thereof), toluene diisocyanate (e.g., toluene-2,4-diisocyanate, toluene-2,6-diisocyanate, or a mixture thereof), naphthylene diisocyanate (e.g., 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, or a mixture thereof), cyclohexylmethane diisocyanate (e.g., 1,4-cyclohexylmethane diisocyanate, 2,4-cyclohexylmethane diisocyanate, 3,4-cyclohexylmethane diisocyanate, 4,4-cyclohexylmethane diisocyanate, or a mixture thereof), dicyclohexylmethane diisocyanate (e.g., 4,4′-dicyclohexylmethane diisocyanate, 1,4-dicyclohexylmethane diisocyanate, or a mixture thereof), or a mixture thereof.

In any aspect or embodiment described herein, the diisocyanate includes or is 4,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the diol chain extender includes or is an aliphatic diol or an aromatic diol. For example, in any aspect or embodiment described herein, the diol chain extender includes or is an alkylene oxide or glycol, ethylene glycol, propanediol (e.g., 1,3-propanediol, 1,2-propanediol, 1,1-propanediol, 2,2-propanediol, or a mixture thereof), butanediol (e.g., 1,4-butanediol, 1,3-butanediol, 1,2-butanediol, 2,3-butanediol, 1,1-butanediol, 2,2-butanediol, or a mixture thereof), pentadiol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptadiol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2,6-heptadiol, 3,3-heptadiol, 3,4-heptadiol, 1,1-heptadiol, 2,2-heptadiol, 3,3-heptadiol, 4,4-heptadiol, or a mixture thereof), dihydroxybenzene (e.g., 1,2-dihydroxybenzene, 1,3-dihydroxybenzene, 1,4-dihydroxybenzene, or a mixture thereof), di(hydroxyethyl)-hydroxyquinone (e.g., 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, or mixtures thereof), di(hydroxymethyl)-hydroxyquinone (e.g., 2,5-di-(hydroxyethyl)-hydroxyquinone, 2,3-di-(hydroxymethyl)-hydroxyquinone, 3,5-di-(hydroxymethyl)-hydroxyquinone, or mixtures thereof), di-(hydroxyethyl)-bisphenol A (e.g., 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A), or a mixture thereof.

In any aspect or embodiment described herein, the diol chain extender includes or is ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof.

In any aspect or embodiment described herein, the diamine chain extender includes or is diaminodiphenylmethane (e.g., 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, or a mixture thereof), dichloro-diaminodiphenylmethane (e.g., 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane, 4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, or a mixture thereof), diaminobenzene (e.g., 1,4-diaminobenzene, 1,2-diaminobenzene, 1,3-diaminobenzene, or a mixture thereof), dimethoxy-diamino biphenyl (e.g., 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl, 4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, or a mixture thereof), dimethyl-diamino biphenyl (e.g., 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl, 4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, or a mixture thereof), diamino biphenyl (e.g., 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, or a mixture thereof), dichloro-diamino biphenyl (e.g., 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl, 4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof), or a mixture thereof.

In any aspect or embodiment described herein, the diamine chain extender includes or is 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof.

In any aspect or embodiment described herein, reactant (i) is present in an amount of about 50 to about 70 wt % of the total molecular weight of the block copolymer.

In any aspect or embodiment described herein, the composition is a thermoplastic polyurethane, hot cast elastomer, cold cast elastomer, microcellular polyurethane foam, polyurethane dispersion in aqueous or organic media, polyurethane adhesive, a one-component polyurethane coating, a two-component polyurethane coating, additive manufacturing composition/resin, or polyurethane sealant.

In any aspect or embodiment described herein, the block copolymer includes or is a reaction product of poly(tetramethylene ether) glycol and ε-caprolactone.

A further aspect of the present disclosure relates to a thermoplastic polyurethane, hot cast elastomer, cold cast elastomer, microcellular polyurethane foam, polyurethane dispersion in aqueous or organic media, polyurethane adhesive, a one-component polyurethane coating, a two-component polyurethane coating, an additive manufacturing composition/resin, or polyurethane sealant, comprising the polyurethane or polyurethane-urea composition of the present disclosure.

An additional aspect of the present disclosure relates to a thermoplastic polyurethane, hot cast elastomer, cold cast elastomer, microcellular polyurethane foam, polyurethane dispersion in aqueous or organic media, polyurethane adhesive, 1-component polyurethane coating, 2-component polyurethane coating, an additive manufacturing composition/resin, or polyurethane sealant, comprising a polyurethane or polyurethane-urea composition comprising a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer; and
(b) at least one diisocyanate,
wherein the polyurethane or polyurethane-urea composition reaction product is formed by reacting (e.g., in the absence of a plasticizer) (a) and (b) in an NCO:OH molar ratio of from about 0.9:1 to about 2:1.

In any aspect or embodiment described herein, the reaction further comprises (c) a diol chain extender, diamine chain extender, or mixture thereof, each having a molecular weight from about 60 to about 600, wherein the polyurethane or polyurethane-urea composition reaction product is formed by reacting, in the absence of a plasticizer, (a), (b), and (c) in an NCO:OH molar ratio of from about 0.9:1 to about 2:1.

In any aspect or embodiment described herein, the composition is processed as a thermoplastic polyurethane, hot cast elastomer or cold cast elastomer.

In any aspect or embodiment described herein, the composition is processed as a thermoplastic polyurethane or hot cast elastomer.

### DETAILED DESCRIPTION OF THE INVENTION

Presently described is a polyurethane or polyurethane-urea composition with the surprising and unexpected enhancement of low temperature performance. In particular, it was discovered that when copolymers of poly(tetrahydrofuran) or poly(substituted tetrahydrofuran) and a cyclic lactone/ether (e.g., caprolactone), wherein (i) the copolymer having molecular weight above 2500 g/mol, (ii) the poly(tetrahydrofuran)/poly(substituted tetrahydrofuran) content is at least 40% by weight of the copolymer, are used as the soft segment in polyurethane articles, the low temperature performance is dramatically improved. The glass transition temperature, which can be measured by Differential Scanning calorimetry (DSC) and/or Dynamic Mechanical Analysis (DMA), is on par with poly(tetramethylene ether) glycols (PTMEG) but more importantly the minimum use temperature (defined as the lowest temperature where tan delta is below 0.1) is extended by up to 25° C. This was a surprising and unexpected affect as polyol crystallization usually increases as the molecular weight increases, raising the minimum use temperature. Polyurethanes based on copolymers have hitherto not been reported, likely due to the belief that polyol crystallinity would prevent useful materials being produced.

The contents of all references, patents, pending patent applications, and published patents, cited throughout the present disclosure are hereby expressly incorporated by reference. The headings used herein are for organizational purposes only and are not meant to be used to limit the scope of the description or the claims, which can be had by reference to the specification as a whole.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the present disclosure. In instances where a term is not specifically defined herein, that term is given an art-recognized meaning by those of ordinary skill applying that term in context to its use in describing the present disclosure.

Where a range of values is provided, it is understood that each intervening value in the range, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges and are also encompassed within the present disclosure, subject to any specifically excluded limit in the stated range. Where the stated range includes one or both of the limits, ranges excluding either/or both of those included limits are also included in the disclosure.

The articles “a,” “an,” and “the”, and similar referents, as used herein and in the appended claims are to be construed to cover both the singular and the plural (for example, “one or more of” or “at least one”) of the grammatical object of the articles, unless otherwise indicated herein or clearly contradicted by context. By way of example, “an element” means one element or more than one element, unless otherwise indicated.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language, such as “comprising,” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also optionally allows elements to be present other than the elements specifically identified within the list of elements to which the phrase “at least one” refers to, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended—that is, to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It should also be understood that, in certain methods or processes described herein that include more than one step or act, the order of the steps or acts of the method is not necessarily limited to the order in which the steps or acts of the method are recited unless the context indicates otherwise. Thus, all methods described herein can be performed in any suitable order unless otherwise indicated herein or otherwise clearly contradicted by context. Further, all methods described herein and having more than one step can be performed by more than one person or entity. Thus, a person or an entity can perform step (a) of a method, another person or another entity can perform step (b) of the method, and a yet another person or a yet another entity can perform step (c) of the method, etc. The use of any and all examples, or exemplary language (for example, “such as”) provided herein is intended merely to better illuminate the inventions of the present disclosure and does not pose a limitation on the scope of the inventions otherwise claimed.

Groupings of alternative elements or embodiments of the inventions disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified, thus fulfilling the written description of all Markush groups used in the appended claims.

The term “substituted” or “optionally substituted” shall mean independently (i.e., where more than one substituent occurs, each substituent is selected independent of another substituent) one or more substituents (e.g., 1, 2, 3, 4, 5, 6, or more) at a carbon (or nitrogen) position anywhere on a molecule or compound within context, and includes as possible substituents hydroxyl, thiol, carboxyl, cyano (CN), nitro (NO₂), halogen, C₁₋₆ or C₂₋₄ haloalkyl, C₁₋₆ or C₁₋₄ alkyl, 6-16 or 6-12 membered aryl (for example, 6-, 7- or 8-membered monocylic aromatic ring, a 10-16 membered aryl having multiple condensed rings, phenyl, substituted phenyl, benzyl, substitute benzyl, or benzoyl), 5-16 or 5-12 membered heteroaryl (for example, aryl with one or more heteroatoms independently selected from N, O, S, or P, or 5-, 6-, 7- or 8-membered monocylic ring or a 10-16 membered heteroaryl having multiple condensed rings), C₁₋₆ or C₁₋₄ alkoxy, ketone, thioether (preferably, C₁-C₆ alkyl or aryl), C₁₋₆ or C₁₋₄ acyl, ester or thioester (preferably, C₁-C₆ alkyl or aryl) including alkylene ester (such that attachment is on the alkylene group, rather than at the ester function which is preferably substituted with a C₁-C₆ alkyl or aryl group), halogen (e.g., F, Cl, Br), C₁₋₆ or C₁₋₄ alkanol, amide, amido, amine (including a five- or six-membered cyclic alkylene amine, a C₁₋₆ of C₁₋₄ alkyl amine, or a C₁₋₆ alkylene-NR₁R₂ or C₁₋₄ alkylene-NR₁R₂, which alkyl groups may be optionally substituted with one or more hydroxyl groups and/or one or more halogen groups), an optionally substituted —N(C₀-C₆ alkyl)C(O)(O—C₁-C₆ alkyl) group, keto, carboxyl, C₁₋₆ester (oxyester or carbonylester), C₁₋₆ keto, —O—C(O)—NR₁R₂ or —N(R₁)—C(O)—O—R₁, —(CH₂)·OH, —(CH₂)ₙSH, —(CH₂)ₙCOOH, C₁-C₆ alkyl, —(CH₂)ₙO—(C₁-C₆ alkyl), —(CH₂)ₙC(O)—(C₁-C₆ alkyl), —(CH₂)ₙOC(O)—(C₁-C₆ alkyl), —(CH₂)ₙC(O)O—(C₁-C₆ alkyl), —(CH₂)ₙNHC(O)—R₁, —(CH₂)ₙC(O)—NR₁R₂, —(OCH₂)ₙOH, —(CH₂O)ₙCOOH, C₁-C₆ alkyl, —(OCH₂)ₙO—(C₁-C₆ alkyl), —(CH₂O)ₙC(O)—(C₁-C₆ alkyl), —(OCH₂)ₙNHC(O)—R₁, —(CH₂O)ₙC(O)—NR₁R₂, —S(O)₂—Rₛ, —S(O)—Rₛ (Rₛ is C₁-C₆ alkyl or a —(CH₂)ₘ—NR₁R₂ group, wherein each n is independently 0, 1, 2, 3, 4, 5, or 6, R₁ and R₂ are each independently H or a C₁₋₆ alkyl group (which may be optionally substituted with 1 or 2 hydroxyl groups and/or 0, 1, 2, or 3 halogen groups). Various optionally substituted moieties may be substituted with 3 or more substituents, preferably no more than 3 substituents and preferably with 1 or 2 substituents. It is noted that in instances where, in a compound at a particular position of the molecule substitution is required (principally, because of valency), but no substitution is indicated, then that substituent is construed or understood to be H, unless the context of the substitution suggests otherwise.

As used herein, “optional” or “optionally” means that the subsequently described event or circumstance may or may not occur, and that the description includes instances where said event or circumstance occurs and instances where it does not.

The present disclosure describes a polyurethane or polyurethane-urea composition with enhanced low temperature performance, compositions comprising the polyurethane or polyurethane-urea composition of the present disclosure, and methods of making and using the compositions of the present disclosure.

An aspect of the present disclosure relates to a polyurethane or polyurethane-urea composition with enhanced low temperature performance. In any aspect or embodiment described herein, the polyurethane or polyurethane-urea composition comprises a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer; and
(b) at least one diisocyanate,
wherein the polyurethane or polyurethane-urea composition reaction product is formed by reacting (e.g., in the absence of a plasticizer) (a) and (b) in an NCO:OH molar ratio of from about 0.9:1 to about 2:1.

In any aspect or embodiment described herein, the reaction further comprises (c) a diol chain extender, diamine chain extender, or mixture thereof, each having a molecular weight from about 60 to about 600, wherein the polyurethane or polyurethane-urea composition reaction product is formed by reacting (e.g., in the absence of a plasticizer) (a), (b), and (c) in an NCO:OH molar ratio of from about 0.9:1 to about 2:1.

In any aspect or embodiment described herein, the polyurethane or polyurethane-urea composition comprises a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer;
(b) at least one diisocyanate; and
(c) a diol chain extender, diamine chain extender, or mixture thereof, each having a molecular weight from about 60 to about 600,
wherein the polyurethane or polyurethane-urea composition reaction product is formed by reacting (e.g., in the absence of a plasticizer) (a), (b), and (c) in an NCO:OH molar ratio of from about 0.9:1 to about 2:1.

In any aspect or embodiment described herein, the at least one block copolymer of A-B-A type has an average number molecular weight from about 2500 to about 5000 g/mol. For example, in any aspect or embodiment described herein, the at least one block copolymer of A-B-A type has an average number molecular weight from about 2500 to about 5000 g/mol, about 2500 to about 4500 g/mol, about 2500 to about 4000 g/mol, about 2500 to about 3500 g/mol, about 3000 to about 5000 g/mol, about 3000 to about 4500 g/mol, about 3000 to about 4000 g/mol, about 3500 to about 5000 g/mol, about 3500 to about 4500 g/mol, or about 4000 to about 5000 g/mol.

In any aspect or embodiment described herein, the poly(tetrahydrofuran) diol, poly(substituted tetrahydrofuran) diol, or a mixture thereof, is present in an amount of about 40 to about 70 wt % of the total molecular weight of the block copolymer. For example, in any aspect or embodiment described herein, the poly(tetrahydrofuran) diol, poly(substituted tetrahydrofuran) diol, or a mixture thereof, is present in an amount of about 40 to about 70 wt %, about 40 to about 65 wt %, about 40 to about 60 wt %, about 40 to about 55 wt %, about 45 to about 70 wt %, about 45 to about 65 wt %, about 45 to about 60 wt %, about 50 to about 70 wt %, about 50 to about 65 wt %, or about 55 to about 75 wt %, of the total molecular weight of the block copolymer. In any aspect or embodiment described herein, reactant (i) is present in an amount of about 50 to about 70 wt % of the total molecular weight of the block copolymer.

In any aspect or embodiment described herein, the cyclic lactone, cyclic ether, or a mixture thereof, that is present in an amount of about 30 to about 60 wt % of the total molecular weight of the block copolymer. For example, in any aspect or embodiment described herein, the cyclic lactone, cyclic ether, or a mixture thereof, that is present in an amount of about 30 to about 60 wt %, about 30 to about 55 wt %, about 30 to about 50 wt %, about 30 to about 45 wt %, about 35 to about 60 wt %, about 35 to about 55 wt %, about 35 to about 50 wt %, about 40 to about 60 wt %, about 40 to about 55 wt %, or about 45 to about 50 wt %, of the total molecular weight of the block copolymer.

In any aspect or embodiment described herein, reactant (b) is present in an amount of about 50 to about 70 wt % of the total molecular weight of the block copolymer. For example, in any aspect or embodiment described herein, reactant (b) is present in an amount of about 50 to about 70 wt %, about 50 to about 65 wt %, about 50 to about 60 wt %, about 55 to about 70 wt %, about 55 to about 65 wt %, or about 60 to about 70 wt %, of the total molecular weight of the block copolymer.

In any aspect or embodiment described herein, the composition has a hardness of about 30 Shore A to about 60 Shore D. For example, in any aspect or embodiment described herein, the composition has a hardness of about 30 Shore A to about 60 Shore D, about 30 Shore A to about 50 Shore D, about 30 Shore A to about 40 Shore D, about 30 Shore A to about 30 Shore D, about 30 Shore A to about 70 Shore A, about 30 Shore A to about 60 Shore A, about 40 Shore A to about 60 Shore D, about 40 Shore A to about 50 Shore D, about 40 Shore A to about 40 Shore D, about 40 Shore A to about 30 Shore D, about 40 Shore A to about 70 Shore A, about 50 Shore A to about 60 Shore D, about 50 Shore A to about 50 Shore D, about 50 Shore A to about 40 Shore D, about 50 Shore A to about 30 Shore D, about 50 Shore A to about 70 Shore A, about 60 Shore A to about 60 Shore D, about 60 Shore A to about 50 Shore D, about 60 Shore A to about 40 Shore D, about 60 Shore A to about 30 Shore D, about 70 Shore A to about 60 Shore D, about 70 Shore A to about 50 Shore D, or about 30 Shore D to about 60 Shore D.

In any aspect or embodiment described herein, the NCO:OH molar ratio is about 0.9:1 to about 1.7:1. In any aspect or embodiment described herein, the NCO:OH molar ratio is about 0.95:1 to about 1.5:1. In any aspect or embodiment described herein, the NCO:OH molar ratio is about 1:1 to about 1.2:1.

In any aspect or embodiment described herein, the polyurethane or polyurethane-urea composition has a glass transition temperature, as measured by Differential Scanning calorimetry, that is below −60° C. For example, in any aspect or embodiment described herein, the polyurethane or polyurethane-urea composition has a glass transition temperature, as measured by Dynamic Mechanical Analysis, that is below −60° C., −55° C., −50° C., −45° C., −40° C., −35° C., or −30° C.

In any aspect or embodiment described herein, reactant (i) includes or is a poly(substituted tetrahydrofuran) diol. For example, in any aspect or embodiment described herein, reactant (i) is a poly(substituted tetrahydrofuran) diol, wherein substituted is one or more (e.g., 1, 2, 3, 4, 5, 6, or more) substitutions independently selected from a C₁₋₄ alkyl (for example, a methyl, ethyl, or propyl), C₁₋₆alkoxy (for example, methoxy or ethoxy), C₂₋₆ alkenyl, aromatic (e.g. phenyl, aryl, or heteroaryl), ester, halogen, halide, amide, or ketone. In any aspect or embodiment described herein, the poly(tetrahydrofuran) diol or reactant (i) includes or is poly(tetramethylene ether) glycol (PTMEG). In any aspect or embodiment described herein, the poly(substituted tetrahydrofuran) diol or reactant (i) includes or is Me-PTMEG.

In any aspect or embodiment described herein, the cyclic lactone includes or is ε-caprolactone.

In any aspect or embodiment described herein, the cyclic ether includes or is ethylene oxide, propylene oxide, 1,2-butylene oxide, 2,3-butylene oxide, or a mixture thereof.

In any aspect or embodiment described herein, the diisocyanate includes or is an aliphatic diisocyanate, aromatic diisocyanate, or a combination thereof. For example, in any aspect or embodiment described herein, the diisocyanate includes or is 4,4′-diphenylmethane diisocyanate, isophorone diisocyanate, bimethylene diisocyanate, trimethylene diisocyanate (e.g., 1,3-trimethylene diisocyanate, 2,3-trimethylene diisocyanate, 1,2-trimethylene diisocyanate, 2,2-trimethylene diisocyanate, or a mixture thereof), tetramethylene diisocyanate (e.g., 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, or a mixture thereof), pentamethylene diisocyanate (e.g., 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, or a mixture thereof), hexamethylene diisocyanate (e.g., 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, or a mixture thereof), heptamethylene diisocyanate (e.g., 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, or a mixture thereof), toluene diisocyanate (e.g., toluene-2,4-diisocyanate, toluene-2,6-diisocyanate, or a mixture thereof), naphthylene diisocyanate (e.g., 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, or a mixture thereof), cyclohexylmethane diisocyanate (e.g., 1,4-cyclohexylmethane diisocyanate, 2,4-cyclohexylmethane diisocyanate, 3,4-cyclohexylmethane diisocyanate, 4,4-cyclohexylmethane diisocyanate, or a mixture thereof), dicyclohexylmethane diisocyanate (e.g., 4,4′-dicyclohexylmethane diisocyanate, 1,4-dicyclohexylmethane diisocyanate, or a mixture thereof), or a mixture thereof.

In any aspect or embodiment described herein, the diisocyanate includes or is 4,4′-diphenylmethane diisocyanate, isophorone diisocyanate, bimethylene diisocyanate, 1,3-trimethylene diisocyanate, 2,3-trimethylene diisocyanate, 1,2-trimethylene diisocyanate, 2,2-trimethylene diisocyanate, 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, 1,5-pentamethylene diisocyanate, 1,4-pentamethylene diisocyanate, 1,3-pentamethylene diisocyanate, 1,3-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, toluene-2,4-diisocyanate, toluene-2,6-diisocyanate, 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, 1,4-cyclohexylmethane diisocyanate, 2,4-cyclohexylmethane diisocyanate, 3,4-cyclohexylmethane diisocyanate, 4,4-cyclohexylmethane diisocyanate, 4,4′-dicyclohexylmethane diisocyanate, 1,4-dicyclohexylmethane diisocyanate, or a mixture thereof.

In any aspect or embodiment described herein, the diisocyanate includes or is 4,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the diol chain extender includes or is an aliphatic diol or an aromatic diol. For example, in any aspect or embodiment described herein, the diol chain extender includes or is an alkylene oxide or glycol, ethylene glycol, propanediol (e.g., 1,3-propanediol, 1,2-propanediol, 1,1-propanediol, 2,2-propanediol, or a mixture thereof), butanediol (e.g., 1,4-butanediol, 1,3-butanediol, 1,2-butanediol, 2,3-butanediol, 1,1-butanediol, 2,2-butanediol, or a mixture thereof), pentadiol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptadiol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2,6-heptadiol, 3,3-heptadiol, 3,4-heptadiol, 1,1-heptadiol, 2,2-heptadiol, 3,3-heptadiol, 4,4-heptadiol, or a mixture thereof), dihydroxybenzene (e.g., 1,2-dihydroxybenzene, 1,3-dihydroxybenzene, 1,4-dihydroxybenzene, or a mixture thereof), di(hydroxyethyl)-hydroxyquinone (e.g., 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, or mixtures thereof), di(hydroxymethyl)-hydroxyquinone (e.g., 2,5-di-(hydroxyethyl)-hydroxyquinone, 2,3-di-(hydroxymethyl)-hydroxyquinone, 3,5-di-(hydroxymethyl)-hydroxyquinone, or mixtures thereof), di-(hydroxyethyl)-bisphenol A (e.g., 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A, or mixture thereof), or a mixture thereof.

In any aspect or embodiment described herein, the diol chain extender includes or is ethylene glycol, 1,3-propanediol, 1,2-propanediol, 1,1-propanediol, 2,2-propanediol, 1,4-butanediol, 1,3-butanediol, 1,2-butanediol, 2,3-butanediol, 1,1-butanediol, 2,2-butanediol, 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2,6-heptadiol, 3,3-heptadiol, 3,4-heptadiol, 1,1-heptadiol, 2,2-heptadiol, 3,3-heptadiol, 4,4-heptadiol, 1,2-dihydroxybenzene, 1,3-dihydroxybenzene, 1,4-dihydroxybenzene, 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, 2,5-di-(hydroxyethyl)-hydroxyquinone, 2,3-di-(hydroxymethyl)-hydroxyquinone, 3,5-di-(hydroxymethyl)-hydroxyquinone, 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A, or a mixture thereof.

In any aspect or embodiment described herein, the diol chain extender includes or is ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof.

In any aspect or embodiment described herein, the diamine chain extender includes or is diaminodiphenylmethane (e.g., 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, or a mixture thereof), dichloro-diaminodiphenylmethane (e.g., 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane, 4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, or a mixture thereof), diaminobenzene (e.g., 1,4-diaminobenzene, 1,2-diaminobenzene, 1,3-diaminobenzene, or a mixture thereof), dimethoxy-diamino biphenyl (e.g., 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl, 4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, or a mixture thereof), dimethyl-diamino biphenyl (e.g., 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl, 4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, or a mixture thereof), diamino biphenyl (e.g., 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, or a mixture thereof), dichloro-diamino biphenyl (e.g., 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl, 4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof), or a mixture thereof.

In any aspect or embodiment described herein, the diamine chain extender includes or is 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane, 4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, 1,4-diaminobenzene, 1,2-diaminobenzene, 1,3-diaminobenzene, 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl, 4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl, 4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl, 4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof.

In any aspect or embodiment described herein, the diamine chain extender includes or is 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof.

In any aspect or embodiment described herein, the block copolymer includes or is a reaction product of poly(tetramethylene ether) glycol and ε-caprolactone.

A further aspect of the present disclosure relates to a thermoplastic polyurethane comprising the polyurethane or polyurethane-urea composition of the present disclosure.

An additional aspect of the present disclosure relates to a hot cast elastomer comprising the polyurethane or polyurethane-urea composition of the present disclosure.

Yet another aspect of the present disclosure relates to a cold cast elastomer comprising the polyurethane or polyurethane-urea composition of the present disclosure.

Another aspect of the present disclosure relates to a microcellular polyurethane foam comprising the polyurethane or polyurethane-urea composition of the present disclosure.

Yet a further aspect of the present disclosure relates to a polyurethane dispersion in aqueous or organic media, comprising the polyurethane or polyurethane-urea composition of the present disclosure.

An additional aspect of the present disclosure relates to polyurethane adhesive comprising the polyurethane or polyurethane-urea composition of the present disclosure.

A further aspect of the present disclosure relates to a one-component polyurethane coating comprising the polyurethane or polyurethane-urea composition of the present disclosure.

Yet another aspect of the present disclosure relates to a two-component polyurethane coating comprising the polyurethane or polyurethane-urea composition of the present disclosure.

Another aspect of the present disclosure relates to an additive manufacturing composition/resin comprising the polyurethane or polyurethane-urea composition of the present disclosure.

Yet a further aspect of the present disclosure relates to a polyurethane sealant comprising the polyurethane or polyurethane-urea composition of the present disclosure.

An additional aspect of the present disclosure relates to a thermoplastic polyurethane, hot cast elastomer, cold cast elastomer, microcellular polyurethane foam, polyurethane dispersion in aqueous or organic media, polyurethane adhesive, 1-component polyurethane coating, 2-component polyurethane coating, additive manufacturing composition/resin, or polyurethane sealant, comprising a polyurethane or polyurethane-urea composition described herein. For example, the polyurethane or polyurethane-urea composition comprising a reaction product of:
(a) at least one block copolymer of A-B-A type having an average number molecular weight from 2500 to 5000 g/mol, wherein said block copolymer comprises or is a reaction product of
   (i) a poly(tetrahydrofuran) diol, poly(substituted tetrahydrofuran) diol, or a mixture thereof, that is present in an amount of about 40 to about 70 wt % of the total molecular weight of the block copolymer; and
   (ii) a cyclic lactone, cyclic ether, or a mixture thereof, that is present in an amount of about 30 to about 60 wt % of the total molecular weight of the block copolymer; and
(b) at least one diisocyanate,
wherein the polyurethane or polyurethane-urea composition reaction product is formed by reacting (e.g., in the absence of a plasticizer) (a) and (b) in an NCO:OH molar ratio of from about 0.9:1 to about 2:1.

In any aspect or embodiment described herein, the reaction further comprises (c) a diol chain extender, diamine chain extender, or mixture thereof, each having a molecular weight from about 60 to about 600, wherein the polyurethane or polyurethane-urea composition reaction product is formed by reacting (e.g., in the absence of a plasticizer) (a), (b), and (c) in an NCO:OH molar ratio of from about 0.9:1 to about 2:1.

In any aspect or embodiment described herein, the composition is processed as a thermoplastic polyurethane, hot cast elastomer, or cold cast elastomer.

In any aspect or embodiment described herein, the composition is processed as a thermoplastic polyurethane or hot cast elastomer.

### EXAMPLES

Polycaprolactone copolymers were produced by reacting the ε-caprolactone (Component A) in a ring-opening polymerization with PTMEG or Me-PTMEG (Component B) according to the formulations in Table 1.

The reactions were performed at 180° C. in the presence of stannous octoate (DABCO® T-9, Evonik Nutrition & Care GmbH, Essen, Germany) as catalyst and monitored by gas chromatography (GC) determination of residual ε-caprolactone. The reactions were terminated when the amount of residual ε-caprolactone was less than 0.5%.

TABLE 1

| | Molecular Weight | | | |
|---|---|---|---|---|
| Example | of Polyol | Component B | Component A | B:A |
| 1 | 3000 | PTMEG | ε-caprolactone | 60:40 |
| 2 | 3000 | PTMEG | ε-caprolactone | 47:53 |
| 3* | 3000 | PTMEG | ε-caprolactone | 33:66 |
| 4* | 2000 | PTMEG | ε-caprolactone | 50:50 |
| 5* | 2000 | PTMEG | ε-caprolactone | 70:30 |
| 6* | 2000 | PTMEG | — | — |
| 7* | 3000 | PTMEG | — | — |
| 8 | 3000 | Me-PTMEG | ε-caprolactone | 66:33 |
| 9* | 3000 | Me-PTMEG | ε-caprolactone | 33:66 |

*Comparative example

To prepare polyurethane elastomer materials according to Table 2 the requisite polyol was first added dropwise to molten 4,4′-diphenylmethanediisocyanate and reacted at 80° C. until the target NCO content was achieved. To this, 1,4-butanediol was added, according to 97% stoichiometry or 103 isocyanate index, and the mixture homogenized using a vortex mixer for 2 minutes. The reaction mixture was then poured onto a coated metal plate that had been conditioned at 120° C. for 1 hour. The cast sheets were then placed in an oven at 120° C. for 16 hours before being demoulded and cooled to 23° C.

TABLE 2

| | Amount | Amount | | Amount | Hard Segment |
|---|---|---|---|---|---|
| | of | of | | of | Amount** |
| | Polyol | MDI | % NCO of | 1,4-BDO | [MDI + BDO] |
| Example | (parts) | (parts) | prepolymer | (parts) | (parts) |
| 1 | 100 | 36.9 | 7.2 | 9.9 | 46.8 |
| 2 | 100 | 36.9 | 7.2 | 9.9 | 46.8 |
| 3* | 100 | 36.9 | 7.2 | 9.9 | 46.8 |
| 4* | 100 | 38 | 6.2 | 8.8 | 46.8 |
| 5* | 100 | 38 | 6.2 | 8.8 | 46.8 |
| 6* | 100 | 38 | 6.2 | 8.8 | 46.8 |
| 7* | 100 | 36.9 | 7.2 | 9.9 | 46.8 |
| 8 | 100 | 36.9 | 7.2 | 9.9 | 46.8 |
| 9* | 100 | 36.9 | 7.2 | 9.9 | 46.8 |

*Comparative example
**The hard segment content was kept the same for each sample so PUs prepared with different molecular weight polyols could be compared directly.

The thermal properties of the polyurethane elastomers were determined using DSC and the thermomechanical properties using DMA.

A Discovery DSC 25 (TA Instruments, New Castle, DE, USA) equipped with a liquid nitrogen cooling system was employed for determining the phase transitions of polyurethane samples. The instrument was calibrated with Indium for melting temperature and enthalpy. Samples of 2-5 mg were encapsulated in Tzero® aluminum pans (TA Instruments, New Castle, DE, USA). Thermograms were produced using the following heat-cool-heat cycles:
1. Heat from −120° C. to between 230° C. and 250° C. (depends on the polyol class and/or molecular weight) at a rate of 20° C./minute,
2. Cool to −120° C. at a rate of 10° C./minute, and
3. Reheat to between 230° C. and 250° C. at a heating rate of 20° C./minute.

Thermograms were analyzed using the TRIOS software (TA Instruments, New Castle, DE, USA) and the glass transition temperature (Tg) was determined.

The thermomechanical properties of polyurethane elastomers were measured using a Discovery DMA 850 (TA Instruments, New Castle, DE, USA). The equipment was operated in single cantilever mode, employing a 20 mm (1)×12 mm (w)×2 mm (t) specimen, held between a stationary and moveable clamp (test length 4 mm). Temperature scans were performed from −100° C. to 200° C. at a rate of 3° C./minute and a constant frequency of 1 Hz. Strain mode was used, and the displacement amplitude set to 50 μm.

The glass transition temperature as measured by DMA was determined as the peak of the tan delta curve. The minimum use temperature was determined as the lowest temperature at which tan delta was below 0.1.

TABLE 3

| | Glass transition | Glass transition | Minimum Use |
|---|---|---|---|
| | temperature | temperature | Temperature |
| | (determined by | (determined by | (determined by |
| Example | DSC), ° C. | DMA), ° C. | DMA), ° C. |
| 1 | −67.4 | −48.0 | −16.9 |
| 2 | −62.6 | −48.7 | −25.1 |
| 3* | −57.4 | −36.6 | −15.4 |
| 4* | −53.2 | −33.1 | −10.8 |
| 5* | −59.7 | −36.6 | −12.2 |
| 6* | −67.3 | −44.9 | −5.2 |
| 7* | −73.1 | −52.7 | 6.8 |
| 8 | −66.9 | −46.6 | −19.9 |
| 9* | −55.7 | −38.9 | −16.9 |

*Comparative example not according to the invention

The data support the surprising and unexpected affects discussed herein.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure may be utilized in numerous combinations, all of which are expressly contemplated by the present description. These additional aspects and embodiments are expressly included within the scope of the present disclosure. The publications and other materials used herein to illuminate the background of the present disclosure, and in particular cases, to provide additional details respecting the practice, are incorporated by reference.

Thus, those skilled in the art will recognize, or be able to ascertain using no more than routine experimentation, many equivalents to the specific embodiments of the present disclosure. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A polyurethane or polyurethane-urea composition with enhanced low temperature performance, the composition comprising a reaction product of:
(a) at least one block copolymer of A-B-A type having an average number molecular weight from 2500 to 5000 g/mol, wherein said block copolymer comprises or is a reaction product of
(i) a poly(tetrahydrofuran) diol, poly(substituted tetrahydrofuran) diol, or a mixture thereof, that is present in an amount of about 40 to about 70 wt % of the total molecular weight of the block copolymer; and
(ii) a cyclic lactone, cyclic ether, or a mixture thereof, that is present in an amount of about 30 to about 60 wt % of the total molecular weight of the block copolymer; and
(b) at least one diisocyanate,
wherein the polyurethane or polyurethane-urea composition reaction product is formed by reacting (a) and (b) in an NCO:OH molar ratio of from about 0.9:1 to about 2:1.

2. The composition of claim 1, wherein the reaction further comprises (c) a diol chain extender, diamine chain extender, or mixture thereof, each having a molecular weight from about 60 to about 600, wherein the polyurethane or polyurethane-urea composition reaction product is formed by reacting, in the absence of a plasticizer, (a), (b), and (c) in an NCO:OH molar ratio of from about 0.9:1 to about 2:1.

3. The composition of claim 1, wherein:
reactant (b) is present in an amount of about 50 to about 70 wt % of the total molecular weight of the block copolymer;
reactant (i) is present in an amount of about 50 to about 70 wt % of the total molecular weight of the block copolymer;
the composition has a hardness in the range of about 30 Shore A to about 60 Shore D;
the composition has a glass transition temperature, as measured by Differential Scanning calorimetry, that is below −60° C.;
the NCO:OH molar ratio is about 0.9:1 to about 1.7:1; or
a combination thereof.

4. The composition of claim 3, wherein:
the NCO:OH molar ratio is from about 1:1 to about 1.2:1;
the composition has a glass transition temperature, as measured by Dynamic Mechanical Analysis, that is below −40° C.; or
a combination thereof.

5. The composition of claim 1, wherein reactant (i) includes or is:
a poly(substituted tetrahydrofuran) diol;
a poly(substituted tetrahydrofuran) diol with one or more substitutions independently selected from a C₁₋₄ alkyl, C₁₋₆ alkoxy, C₂₋₆ alkenyl, aromatic, ester, halogen, halide, amide, or ketone; or
a combination thereof.

6. The composition of claim 1, wherein reactant (i) includes or is poly(tetramethylene ether) glycol (PTMEG) or Me-PTMEG.

7. The composition of claim 1, wherein the cyclic lactone is ε-caprolactone.

8. The composition of claim 1, wherein the cyclic ether is ethylene oxide, propylene oxide, 1,2-butylene oxide, 2,3-butylene oxide, or a mixture thereof.

9. The composition of claim 1, wherein the diisocyanate includes or is an aliphatic diisocyanate, aromatic diisocyanate, or a combination thereof.

10. The composition of claim 1, wherein the diisocyanate includes or is 4,4′-diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof.

11. The composition of claim 1, wherein the diisocyanate includes or is 1,3-trimethylene diisocyanate, 2,3-trimethylene diisocyanate, 1,2-trimethylene diisocyanate, 2,2-trimethylene diisocyanate, 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, toluene-2,4-diisocyanate, toluene-2,6-diisocyanate, 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, 1,4-cyclohexylmethane diisocyanate, 2,4-cyclohexylmethane diisocyanate, 3,4-cyclohexylmethane diisocyanate, 4,4-cyclohexylmethane diisocyanate, 4,4′-dicyclohexylmethane diisocyanate, 1,4-dicyclohexylmethane diisocyanate, or a mixture thereof.

12. The composition of claim 1, wherein the diisocyanate is 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

13. The composition of claim 2, wherein the diol chain extender includes or is an aliphatic diol or an aromatic diol.

14. The composition of claim 2, wherein the diol chain extender includes or is an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof.

15. The composition of claim 2, wherein the diol chain extender includes or is 1,3-propanediol, 1,2-propanediol, 1,1-propanediol, 2,2-propanediol, 1,4-butanediol, 1,3-butanediol, 1,2-butanediol, 2,3-butanediol, 1,1-butanediol, 2,2-butanediol, 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2,6-heptadiol, 3,3-heptadiol, 3,4-heptadiol, 1,1-heptadiol, 2,2-heptadiol, 3,3-heptadiol, 4,4-heptadiol, 1,2-dihydroxybenzene, 1,3-dihydroxybenzene, 1,4-dihydroxybenzene, 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, 2,5-di-(hydroxyethyl)-hydroxyquinone, 2,3-di-(hydroxymethyl)-hydroxyquinone, 3,5-di-(hydroxymethyl)-hydroxyquinone, 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A), 3,5-di-(betahydroxyethyl)-bisphenol A, or a mixture thereof.

16. The composition of claim 2, wherein the diamine chain extender includes or is diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof.

17. The composition of claim 2, wherein the diamine chain extender includes or is 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane, 4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, 1,4-diaminobenzene, 1,2-diaminobenzene, 1,3-diaminobenzene, 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl, 4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl, 4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl, 4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof.

18. The composition of claim 2, wherein:
the diol chain extender is ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof;
the diamine chain extender is 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof; or
a combination thereof.

19. The composition of claim 1, wherein the composition is a thermoplastic polyurethane, hot cast elastomer, cold cast elastomer, microcellular polyurethane foam, polyurethane dispersion in aqueous or organic media, polyurethane adhesive, a one-component polyurethane coating, a two-component polyurethane coating, additive manufacturing composition/resin, or polyurethane sealant.

20. A thermoplastic polyurethane, hot cast elastomer, cold cast elastomer, microcellular polyurethane foam, polyurethane dispersion in aqueous or organic media, polyurethane adhesive, a one-component polyurethane coating, a two-component polyurethane coating, additive manufacturing composition/resin, or polyurethane sealant, comprising the polyurethane or polyurethane-urea composition of claim 1.
